(19) United States
(12) Patent Application Publication
(10) Pub. No.: US 2023/0137459 A1
(43) Pub. Date: May 4, 2023

(54) PROACTIVE SIMULATION BASED CYBER-THREAT PREVENTION

(71) Applicant: International Business Machines Corporation, Armonk, NY (US)

(72) Inventors: Venkata Vara Prasad Karri, Visakhapatnam (IN); Sarbajit K. Rakshit, Kolkata (IN)

(21) Appl. No.: 17/512,979

(22) Filed: Oct. 28, 2021

(51) Int. Cl. H04L 29/06; G06T 19/00

(52) U.S. Cl. CPC H04L 63/1416; H04L 63/1425; H04L 63/1466; G06T 19/006

(57) ABSTRACT

A processor may receive guidance information from one or more devices. The one or more devices may be in a physical environment. The processor may generate a virtual reality (VR) environment based on the physical environment. The processor may generate a guidance of the guidance information in the VR environment. The processor may determine whether the guidance of the guidance information is performable. The processor may notify a user of the performability of the guidance.

### BACKGROUND

The present disclosure relates generally to the field of cyber-threat prevention, and more specifically to proactively preventing cyber-threats based on simulations.

Virtual Reality (VR) systems can be used for remote guidance to perform any physical activity. While using VR devices a user can perform activity in a physical surrounding. In this case, the VR system can guide the user to perform the activity, but if the VR system contains any incorrect/malicious code, then the VR system can provide misleading guidance to the user.

### SUMMARY

Embodiments of the present disclosure include a method, computer program product, and system for proactive simulation based cyber-threat prevention. A processor may receive guidance information from one or more devices. The one or more devices may be in a physical environment. The processor may generate a virtual reality (VR) environment based on the physical environment. The processor may generate a guidance of the guidance information in the VR environment. The processor may determine whether the guidance of the guidance information is performable. The processor may notify a user of the performability of the guidance.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example VR system, in accordance with aspects of the present disclosure.

FIG. 2 illustrates a flowchart of an example method for proactive simulation based cyber-threat prevention, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of cyber-threat prevention, and more specifically to proactively preventing cyber-threats based on simulations. While the present disclosure is not necessarily limited to such applications, various aspects of the disclosure may be appreciated through a discussion of various examples using this context.

While interacting with a VR system, a user can get disconnected from their physical surroundings, in this sense, the VR system will be taking the user to different, simulated world. While interacting with VR system and in the simulated world, the user can both perform mobility physically and/or virtually. Due to this feature, VR systems are being used for remote guidance to perform any activity that could be performed in a physical environment.

The problem with VR systems, because they can be used for remote guidance to perform any physical activity, and while using VR devices a user can perform activity in a physical surrounding, the VR system can guide the user to perform the activity, but if the VR system contains any incorrect/malicious code (e.g., is a cyber-threat), then the VR system can provide misleading guidance to the user (e.g., which may cause an accident). Accordingly, provided herein is a solution by which, while a user performs any activity in a physical surrounding with VR based guidance, then before, and while, performing the activity in the physical surrounding, an Internet-of-Things (IoT) enabled system in communication with the VR system/device will be validating if the guidance provided by the VR system is proper and an appropriate notification will be provided to the user (e.g., “okay to perform this action,” “do not perform this action,” etc.).

Before turning to the FIGS. it is noted that the benefits/novelties and intricacies of the proposed solution are that:

An IoT enabled system of any physical surrounding can be receiving guidance provided by any VR enabled system/device (e.g., a VR system may be a system that includes more than one VR device, such as a VR headset with VR handheld controllers, etc.) to perform any activity in the said physical environment. Accordingly the proposed solution/system may be simulating if a guidance that is provided in/to the VR device can be executed in the physical environment;

Based on a simulated result by the IoT enabled system (which includes the VR system/device), if the proposed system predicts that the user's activities as per the guidance in the VR environment can create any accident in the physical environment, then the user will be notified, or will be brought back from VR environment to physical surrounding (e.g., the VR system/device will be shut off);

The IoT enabled system may analyze the guidance provided by the VR system/device (e.g., the IoT enabled system may monitor actions of a user performing the guidance; the user may opt-in to being monitored), and if the VR based guidance is not complete, or additional activity/steps are to be performed by the user to complete the VR based guidance, then the IoT enabled system may overlay appropriate suggestions/cautions (e.g., notifications, indicators) within the VR surrounding/environment (e.g., generate a digital notification over a simulated object that indicates that the user should pull a lever, etc.);

Based on a pattern of the guidance provided by the VR based system, the proposed IoT enabled system may be able to determine if the guidance provided by/to the VR system is erroneous/misleading and can predict if the VR content is malicious. Accordingly, the proposed system may disable some of the sensors in the VR system/device, so that information from the physical surrounding will be restricted. For example, if the guidance indicates an incorrect placement of an object in the VR environment (simulated environment), the sensor of the VR system/device communicating with the IoT monitoring device (e.g., camera, motion sensor, etc.) may be shut off/have its communication disabled, which may prevent a possible accident/cyber-threat; and

If a user has already executed the guidance provided by/to the VR enabled system, then the proposed IoT enabled system can overlay appropriate caution/indications/etc., within the VR environment so that the accident in the physical environment can be restricted/avoided.

In some embodiments, the proposed solution may have a self-learning mechanism. In such an instance, the proposed solution will gather (in a repository, historical database, etc.) what types of suggestions/indications are provided by the VR system for specific guidance's, types of accidents that a guidance may cause, etc., and accordingly be identifying the VR software that may have malicious code.

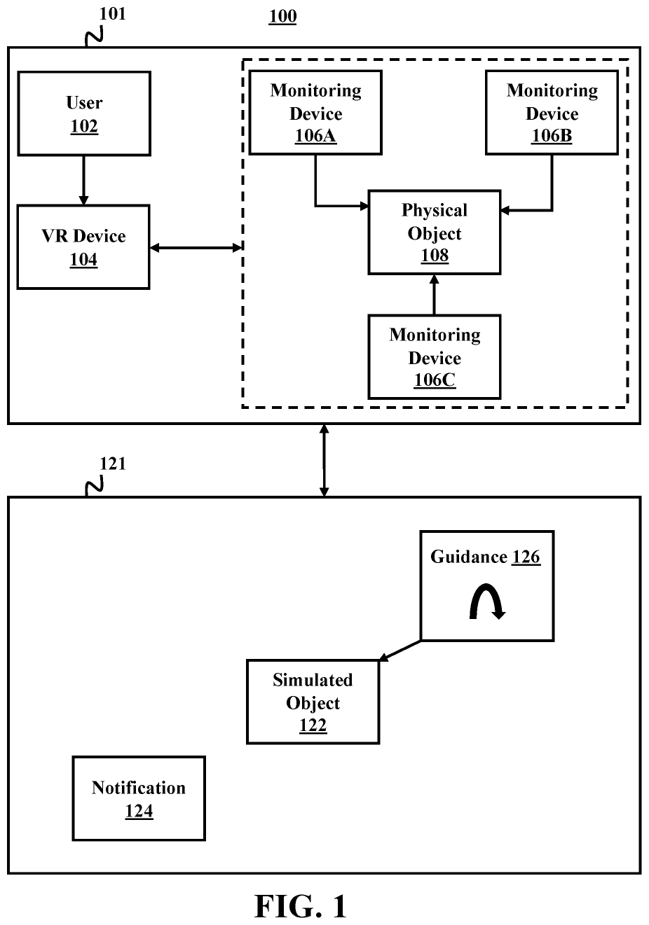

Referring now to FIG. 1, illustrated is a block diagram of an example VR system 100, in accordance with aspects of the present disclosure. As depicted, the VR system 100 includes a physical environment 101 and a simulated environment 121. In some embodiments, the physical environment 101 may be boundaried based on user input (e.g., via an internet network provided by the user, a geofence set by the user, etc.) and/or based on placement of monitoring devices (e.g., 106A-C, which may be placed in certain areas within a physical location). In some embodiments, the simulated environment 121 is a simulated version of the physical environment 101 and the simulated environment may include a simulation of any or every object/device in the physical environment 101.

In some embodiments, as depicted, the physical environment 101 includes a user 102, a VR device 104 (e.g., a headset, a smartphone, a tablet, etc.), monitoring devices 106A-C (e.g., motion sensors, cameras, thermal sensors, etc.), and a physical object 108. Further, as depicted, the simulated environment 121 includes a simulated object 122 (which may be a simulated/digital replica [digital twin] of the physical object 108), a notification 124, and a guidance 126. In some embodiments, the VR system 101 simulates if the (VR based) guidance 126 is safe/performable (e.g., on/by the simulated object 122 [and by way of the simulation safe/performable on the physical object 108]), and accordingly, an appropriate notification 124 (e.g., warning, indicator, banner, etc.) will be provided to the user 102 in the simulated environment 121 (e.g., via usage of the VR device 104), or the user 102 may be brought back to the physical environment 101 via the VR device 104 being automatically turned off (e.g., in the case incorrect/malicious code is identified, etc.).

As an in-depth description of the VR system 100, any IoT enabled monitoring device (e.g., 106A-C) which may surround each and every object (e.g., the physical object 108) may identify uniquely, and at the same time, the position of the objects (e.g., each monitoring devices 106A-C may note a position of the physical object 108, the position may be relative to the monitoring location of the monitoring devices 106A-C, and the monitoring devices 106A-C may provide a different point-of-view/characteristic of the physical object 109). Put another way, the monitoring device 106A may be in a location that identifies a lever/knob on the left side of the physical object 108, the monitoring device 106B may not be able to identify the lever/knob, but may be able to identify a button on the right side of the physical object 108, etc.

In some embodiments, a smart home, or office service, provider can gather IoT feeds from various devices and generate correlations/associations among different types of activities (e.g., how the physical object 108 moves/can move, how a user can interact with the physical object 108, etc.), how the activities are performed, etc. (e.g., as depicted by the dashed outline, the IoT feeds from the monitoring devices 106A and/or the physical object 108 [which itself could be a device] can be gathered by a service and provided to the VR device 104).

In some embodiments, the VR system 100 may have a knowledge corpus (not depicted) on types of activities that the devices and/or objects (e.g., the monitoring devices 106A-C and/or the physical object 108) can perform, how the activities are performed (e.g., on and/or by the monitoring devices 106A-C and/or the physical object 108), what type of results can be expected from the activities, etc. For example, the knowledge corpus could indicate if a lever/knob of the physical object 108 is moved in an arching movement toward the right (e.g., guidance 126), the physical object could perform a specified function (e.g., open, close, etc.). In some embodiments, the activities could be performed in the simulated environment 121 and on/by the simulated object 122.

In some embodiments, remote service providers, or the VR system 100 itself via machine learning, may identify which activities might cause an accident in the physical environment 101 and accordingly the same will be used for guiding (e.g., the guidance 126) the user 102 while the user 102 is in the simulated environment 121 (e.g., using the VR device 104). In such an embodiment, the guidance 126 is displayed in the simulated environment 122 with the notification 124, which indicates to the user 108 to not perform the action in the guidance 126 (as it will likely/predictively cause and accident/mishap if performed in the physical environment 101).

In some embodiments, the VR system 100 can be used for guidance (e.g., the guidance 126) to perform physical activity upon the simulated object 122, in this case the VR device 104 may provide step-by-step guidance to perform the activities. In such an embodiment, the guidance 126 with the notification 124 may indicate that an accident/mishap is not likely to occur.

In some embodiments, if the user 102 starts performing the activities with the VR system 100 (e.g., in the simulated environment 121), such as, how to start any machine, device, or any activity, etc., the user 102 can also use the VR device 104 to play a VR-based game, and during the VR-based game, the VR device 104 may also provide different types of guidance to the user 102, activities to be performed by the user 102, etc. Such an embodiment may be beneficial when trying a new hire to perform a function as activities/guidances are constantly updated and the activities could have no impact in the physical environment 101 (e.g., no accidents could happen in the physical environment 101).

In some embodiments, when the user 102 is using the VR device 104 to perform any activity (from/of the guidance 126), the user 102 may be following the guidance 126 provided by the VR system 100 and if no accident/problem with code arises, the same activity could be performed in the physical environment 101 (e.g., in real life).

In some embodiments, the VR system 100 may provide visual guidance and/or audio-based guidance, so that the user 102 can follow the guidance 126. In some embodiments, the notification 124 may also be visual (e.g., a banner, a text, etc.) and/or audio-based (e.g., a siren, a chime, an automated voice, etc.).

As another aspect of the proposed solution discussed herein, in addition to the VR system 100 being able to predict if an action/guidance is performable (e.g., won't cause and accident), the VR system 100 can also determine if there is incorrect/malicious code in/on VR content (e.g., guidance information); such code could mislead the user 102 to perform an incorrect/unperformable activity.

In some embodiments, if the VR content contains/includes malicious code, then the activity of the user 102 in the simulated environment 121 could also be actions physically executed in the physical environment 101, which can cause an accident (e.g., although the user 102 is performing the guidance 126/an action of the guidance 126 based on the simulated environment 121, the action of the user 102 is still physically being performed in the physical environment 101).

In some embodiments, the VR device 104 may be paired with an AI/ML enabled smart IoT ecosystem. In some embodiments, the VR system 100 may be, or incorporate, the AI/ML enabled smart IoT ecosystem. In this instance, the VR content displayed in/on the VR device 104 (e.g., the simulated environment 121) along with audio and captions (e.g., the notification 124) will be sent to the smart IoT enabled system. Put another way, in such an embodiment, audio and captions could be provided to each device in the ecosystem; such an embodiment may be beneficial to broadcast a predicted result/simulated result of an action on an object (e.g., an engine, a server rack, etc.).

In some embodiments, the AI/ML enabled smart IoT ecosystem may analyze the VR content, e.g., images, audio, captions, etc. and accordingly identify what activities (e.g., guidance 126) are suggested in the simulated environment 121.

In some embodiments, the AI/ML enabled smart IoT ecosystem may identify what activities (e.g., guidance 126, of the guidance 126, etc.) are suggested to be performed in/with the VR device 104, and accordingly the activities may be simulated by the VR system 100 and the simulation may be displayed in the simulated environment 121.

In some embodiments, the AI/ML enabled smart IoT ecosystem may simulate the guidance 126 provided by the VR system 100 and provide it via the notification 124 to the physical environment 101 (e.g., if the guidance 126 is determined to be performable/not malicious code, the notification 124 cannot be displayed to the user 102 in the simulated environment 121, but on a device/display in the physical environment 101).

In some embodiments, based on simulation results (e.g., determining if the guidance 126 is performable), the VR system 100 identify if the guidance 126 provided in the simulated environment 121 is safe to perform (e.g., is performable) in the physical environment 101.

In some embodiments, if the guidance 126 is performed in the simulated environment 121 and is determined to be safe (e.g., performable, not malicious code, etc.), then the VR system 100 may provide/display an appropriate flag (e.g., the notification 124) indicating that it is acceptable/safe to perform the activity (e.g., guidance 126) on the physical object 108 in the physical environment 101.

In some embodiments, if the guidance 126 is performed in the simulated environment 121 and is determined to be unsafe (e.g., not performable, malicious code, etc.), then the VR system 100 may identify what/which types of difficulties can occur (e.g., accidents that could happen, what could happen if a piece of code is left unchanged, etc.).

In such an embodiment, the VR system 100 may communicate with the VR device displaying the simulated environment 121 to the user 102 and may overlay an appropriate caution (e.g., notification 124) and/or guidance 126 so that the user 102 does not perform the activity, or the VR system 100 may bring back the user 120 to physical environment 101 (e.g., shut off the VR device 104 and/or a monitoring device 106A-C that could be affected by incorrect/malicious code, etc.).

In such an embodiment, the AI/ML enabled smart IoT ecosystem may learn what/which types of guidance (e.g., the guidance 126) are suggested by the VR system 100 and determine/identify if the guidances themselves are problematic, and accordingly the guidances may be flagged (e.g., by indicators, the notification 124, etc.) indicating that those guidances (at least in regard to VR content) are malicious/incorrect, or unperformable.

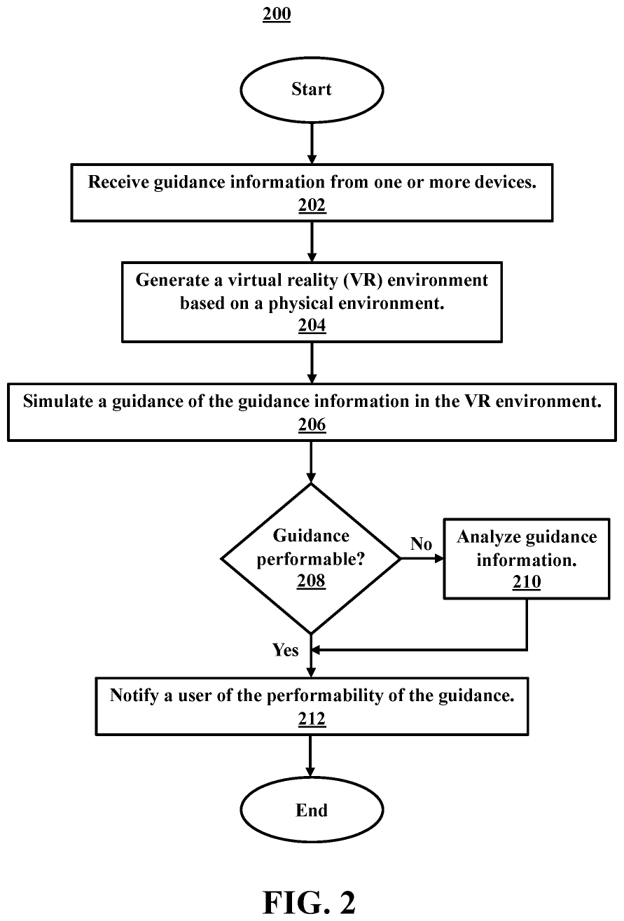

Referring now to FIG. 2, illustrated a flowchart of an example method 200 for proactive simulation based cyber-threat prevention, in accordance with aspects of the present disclosure. In some embodiments, the method 200 may be performed by a processor (e.g., of the VR system 100 of FIG. 1, etc.).

In some embodiments, the method 200 may begin at operation 202. At operation 202 the processor receives guidance information (e.g., code, instructions, etc.) from one or more devices (e.g., monitoring devices, sensors, controllers, etc.). The one or more devices may be in a physical environment. In some embodiments the physical environment may include one or more physical objects that the one or more devices monitor and/or provide guidance on. In some embodiments, the one or more devices may be the physical objects. In some embodiments, the physical environment may be determined by a geofence, a common network for the devices, a physical boundary identified by the one or more devices (e.g., sensor on a fence, etc.), etc.

In some embodiments, the method 200 may proceed to operation 204, where the processor generates a VR (e.g., simulated) environment based on the physical environment. In some embodiments, the method 200 may proceed to operation 206, where the processor may simulate a guidance (e.g., action, activity, etc.) of the guidance information in the VR environment.

In some embodiments, the method 200 proceeds to decision block 208. At decision block 208, it is determined whether the guidance of the guidance information is performable (e.g., in the physical environment and/or based on the VR simulation). If, at decision block 208, it is determined that the guidance is not performable, the method 200 may proceed to operation 210. At operation 210, the processor may analyze the guidance information and/or analyze the simulation of the guidance to identify if the guidance information contains malicious code and/or will cause an accident. In some embodiments, after operation 210, the method 200 may proceed to operation 212, where the processor may notify a user of the performability of the guidance.

In some embodiments, if, at decision block 208, it is determined that the guidance is performable, the method 200 may proceed to operation 212, where the processor may notify (e.g., indicate green if performable, red if not, thumbs up/down emote, etc.) a user of the performability of the guidance. In some embodiments, after operation 212, the method 200 may end.

In some embodiments, discussed below, there are one or more operations of the method 200 not depicted for the sake of brevity and which are discussed throughout this disclosure. Accordingly, in some embodiments, the processor, after analyzing the guidance information/simulation of the guidance, may predict that an error (e.g., accident will happen if the guidance is performed, if there is incorrect/malicious code, etc.) may occur. The error may be predicted to occur based on an error threshold.

In some embodiments, the processor may determine whether the error is from the guidance information including incorrect code. In some embodiments, determining whether the error is from incorrect code may include the processor analyzing the guidance information, identifying the incorrect code within the guidance information, and/or performing a remediation action (e.g., shutting off sensors/monitoring devices, removing the incorrect code, cautioning/notifying users, etc.).

As an example, if a simulated object has multiple gears and it is determined that coding would have the gears have too high an RPM, it could be predicted there is a 90% chance a gear could come loose and cause and accident. The proposed solution could then notify a user of the likely accident and/or prevent the use of the code in the physical environment/on the physical object. In some embodiments, the proposed solution could remove and/or adjust the code to allow for an adequate RPM metric for the gears (as based on AI/ML and/or historical information).

In some embodiments, notifying the user of the performability of the guidance includes overlaying one or more notifications over one or more simulated objects in the VR environment. For example a digital banner may notify a user who is supposed to construct a physical object where placement of parts of the object should be while the user is performing a tutorial in the VR environment (e.g., “this gear should be here” with and arrow pointing to the placement, “this belt should be moved here”, etc.).

In some embodiments, the processor may store the guidance information in a repository and tag the guidance information with an indicator. The indicator may indicate the performability of the guidance. For example, to increase the speed at which the proposed solution can give predicted notifications and/or guidances to a user, the proposed solution may store information about which guidance information performs which functions and/or which are performable or will cause incidences. This allows subsequent guidance information to be categorized and determined/identified to be performable/unperformable more adequately and quickly.

In some embodiments, the processor may receive second guidance information. The processor may access the repository. The processor may compare the second guidance information to the guidance information. The processor may identify that the second guidance information and the guidance information perform the same (or similar) guidance (e.g., this guidance has a machine increase fluid flow and so does this guidance, etc.; the proposed solution may also determine what an acceptable increase in fluid flow is for an object that is predicted to perform the guidance/action). In some embodiments, the processor may automatically perform a remediation action.

In some embodiments, the processor may determine/identify that the guidance information and the second guidance information are not the same and add the second guidance information with a tag to the repository. In some embodiments, it may be determined that the guidance information and the second guidance information are the same or not based on the specific code instructions in the guidances (e.g., both include a call to the same library, etc.).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

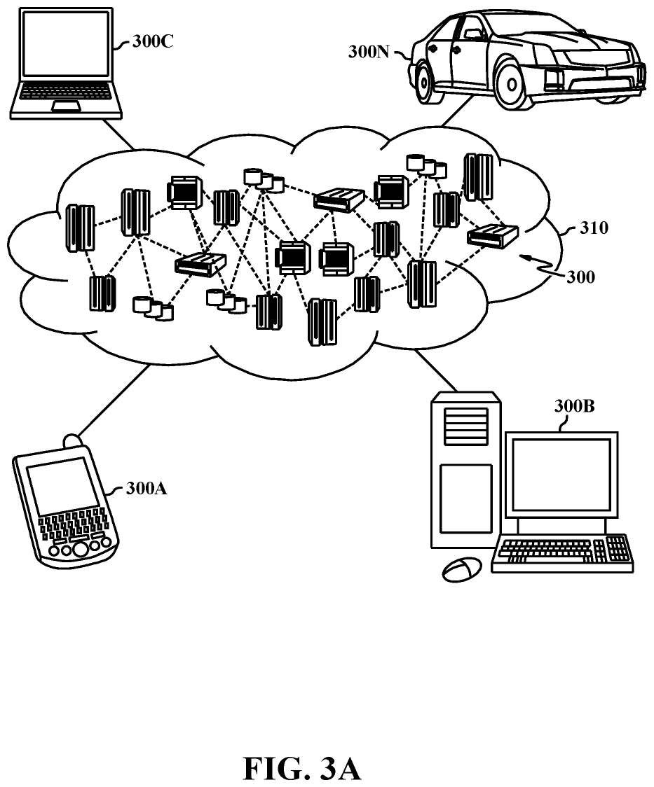

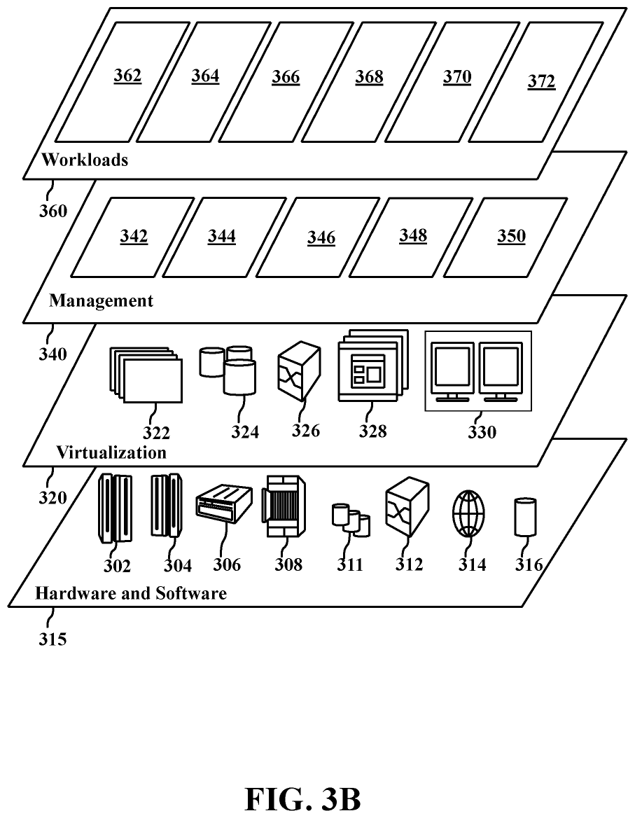

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and proactive simulation based cyber-threat prevention 372.

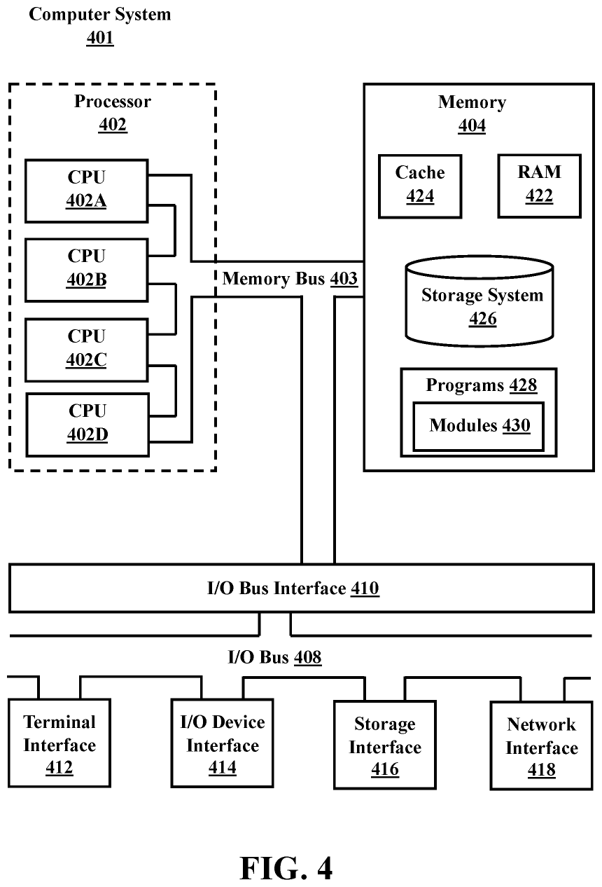

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system for proactive simulation based cyber-threat prevention, the system comprising:
a memory; and
a processor in communication with the memory, the processor being configured to perform operations comprising:
receiving guidance information from one or more devices, wherein the one or more devices are in a physical environment;
generating a virtual reality (VR) environment based on the physical environment;
simulating a guidance of the guidance information in the VR environment; and
determining whether the guidance of the guidance information is performable; and
notifying a user of the performability of the guidance.

2. The system of claim 1, where determining whether the guidance is performable includes:
analyzing the simulation of the guidance; and
predicting that an error will occur, wherein the error is predicted to occur based on an error threshold.

3. The system of claim 2, wherein the processor is further configured to perform operations comprising:
determining whether the error is from the guidance information including incorrect code.

4. The system of claim 3, wherein determining whether the error is from incorrect code includes:
analyzing the guidance information;
identifying the incorrect code within the guidance information; and
performing a remediation action.

5. The system of claim 1, wherein notifying the user of the performability of the guidance includes overlaying one or more notifications over one or more simulated objects in the VR environment.

6. The system of claim 1, wherein the processor is further configured to perform operations comprising:
storing the guidance information in a repository; and
tagging the guidance information with an indicator, wherein the indicator indicates the performability of the guidance.

7. The system of claim 6, wherein the processor is further configured to perform operations comprising:
receiving second guidance information;
accessing the repository;
comparing the second guidance information to the guidance information;
identifying that the second guidance information and the guidance information perform the same guidance; and
automatically performing a remediation action.

8. A computer-implemented method for proactive simulation based cyber-threat prevention, the method comprising:
receiving, by a processor, guidance information from one or more devices, wherein the one or more devices are in a physical environment;
generating a virtual reality (VR) environment based on the physical environment;
simulating a guidance of the guidance information in the VR environment;
determining whether the guidance of the guidance information is performable; and
notifying a user of the performability of the guidance.

9. The computer-implemented method of claim 8, where determining whether the guidance is performable includes:
analyzing the simulation of the guidance; and
predicting that an error will occur, wherein the error is predicted to occur based on an error threshold.

10. The computer-implemented method of claim 9, further comprising:
determining whether the error is from the guidance information including incorrect code.

11. The computer-implemented method of claim 10, wherein determining whether the error is from incorrect code includes:
analyzing the guidance information;
identifying the incorrect code within the guidance information; and
performing a remediation action.

12. The computer-implemented method of claim 8, wherein notifying the user of the performability of the guidance includes overlaying one or more notifications over one or more simulated objects in the VR environment.

13. The computer-implemented method of claim 8, further comprising:
storing the guidance information in a repository; and
tagging the guidance information with an indicator, wherein the indicator indicates the performability of the guidance.

14. The computer-implemented method of claim 13, further comprising:
receiving second guidance information;
accessing the repository;
comparing the second guidance information to the guidance information;
identifying that the second guidance information and the guidance information perform the same guidance; and
automatically performing a remediation action.

15. A computer program product for proactive simulation based cyber-threat prevention comprising a computer readable storage medium having program instructions embodied therewith, the program instructions executable by a processor to cause the processor to perform operations, the operations comprising:
receiving guidance information from one or more devices, wherein the one or more devices are in a physical environment;
generating a virtual reality (VR) environment based on the physical environment;
simulating a guidance of the guidance information in the VR environment;
determining whether the guidance of the guidance information is performable; and
notifying a user of the performability of the guidance.

16. The computer program product of claim 15, where determining whether the guidance is performable includes:
analyzing the simulation of the guidance; and
predicting that an error will occur, wherein the error is predicted to occur based on an error threshold.

17. The computer program product of claim 16, wherein the processor is further configured to perform operations comprising:
determining whether the error is from the guidance information including incorrect code.

18. The computer program product of claim 17, wherein determining whether the error is from incorrect code includes:
analyzing the guidance information;
identifying the incorrect code within the guidance information; and
performing a remediation action.

19. The computer program product of claim 15, wherein notifying the user of the performability of the guidance includes overlaying one or more notifications over one or more simulated objects in the VR environment.

20. The computer program product of claim 15, wherein the processor is further configured to perform operations comprising:
storing the guidance information in a repository; and
tagging the guidance information with an indicator, wherein the indicator indicates the performability of the guidance.
